(19) United States
(12) Patent Application Publication
(10) Pub. No.: US 2019/0235710 A1
(43) Pub. Date: Aug. 1, 2019

(54) Page Turning Method and System for Digital Devices

(71) Applicant: James Wen, Colorado Springs, CO (US)

(72) Inventor: James Wen, Colorado Springs, CO (US)

(21) Appl. No.: 15/881,854

(22) Filed: Jan. 29, 2018

(51) Int. Cl. G06F 3/0483; G06F 3/01; G06F 3/0488; G06F 3/16

(52) U.S. Cl. CPC G06F 3/0483; G06F 3/167; G06F 3/04883; G06F 3/013

(57) ABSTRACT

Embodiments of the present invention disclose a method and system for traversing through digital content displayed on a digital device in a piecewise manner. According to one embodiment, a trigger event is received from a user causing an update of a portion of the display area resulting in discontiguous content being rendered. The balance of the display area is updated with continuous content upon the receipt of a subsequent trigger event.

The present applications claims priority to the earlier filed provisional application having Ser. No. 62/451,639 and hereby incorporates subject matter of the provisional application in its entirety.

### BACKGROUND

An ever increasing amount of content traditionally distributed on paper is being digitized for delivery on computing devices. Devices such as tablet computers, mobile phones, or digital readers are lightweight and can store a tremendous amount of data. Many devices attempt to mimic traditional printed material by allowing users to turn pages in a manner that captures the page turning experience for a book by using three-dimensional graphics to simulate a page being flipped across the screen. However, such interfaces inherit, by design, the disadvantages in traditional page turning, retaining artifacts that may not be desired. For example, when a page of a musical score is turned to progress through the score, the momentary lapse of any readable content may cause a disruption that would be highly undesirable to a musician reciting the piece. Similarly, the reading of a speech or a script may also suffer from a lack of continuity when pages are turned, both in traditional paper-based medium as well as digital devices delivering the same content. Using scrolling displays may provide continuity but at the sacrifice of a static display resulting in a need for greater vigilance by the viewer to track the movement of the content on the display. What is needed is a way for content that needs to be displayed on a digital device in sections, to be rendered in a manner that allows the viewer retain absolute continuity when viewing the content as well as maintain full uninterrupted progress through the content even as the content is being updated.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIG. 1A illustrates an exemplary operating environment for a tablet-based computing device including a touchscreen in accordance with an embodiment of the present invention.

FIG. 1B illustrates an exemplary operating environment for a computing device including a remotely operated foot pedal capable of sending a trigger event in accordance with an embodiment of the present invention.

FIG. 1C illustrates an exemplary operating environment for a computing device including a front-facing camera capable of capturing live video of a user looking at the display.

FIG. 2 is a simplified view of an electronic device displaying electronic content and including user interaction features in accordance with some embodiments of the present invention.

FIGS. 3A through 3F illustrate a process flow for traversing through digital content by turning partial pages in accordance with some embodiments of the present invention.

FIGS. 4A and 4B illustrate an embodiment where the request for updating the content in a partial manner is done through a camera tracking the user's eye gaze in accordance with an embodiment of the present invention.

FIG. 4C illustrates an embodiment where the request for updating the content in a partial manner is done through a camera tracking the user's gesture in accordance with an embodiment of the present invention.

FIG. 4D illustrates an embodiment where the request for updating the content in a partial manner is done through a microphone listening for an audio cue from the user in accordance with an embodiment of the present invention.

FIG. 5 illustrates the processing steps for traversing through electronic content of an electronic device according to an embodiment of the present invention.

FIG. 6A through 6C illustrate a process flow where a visual cue is rendered to indicate the continuous state of the displayed content.

### DETAILED DESCRIPTION OF THE INVENTION

The following discussion is directed to various embodiments. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As computing devices continue to become more portable, books, magazines, newspapers, scripts, musical scores, and other typically paper-based content will be increasingly accessible through digital devices. The traversal of content distributed through traditional paper-based material is experientially different from the traversal of content distributed through digital devices. In particular, rather than physically turning pages, a user traversing digital content may use a simple finger gesture, voice command, remote button, or a variety of other forms to relay an input request to the digital device in order to request a page turn. While the input request can be made through a wide range of actions, the end result is substantially the same: a page turn is actuated and the current content of the display is replaced with content from the requested page. This is generally an accepted and expected behavior but, in certain cases, such as with scripts or musical scores, the replacement of a currently displayed page with a completely new page can cause a discontinuity while the page is being replaced which may result in an undesirable pause in an otherwise smooth progression through the content. While certain digital content delivery systems allow content to be scrolled continuously, the movement of content may be inconvenient since the reader will need to dedicate cognitive attention in order to retain the moving position of the relevant content as it scrolls up a display. This makes short glances elsewhere difficult to attempt lest the position of the content is lost having moved during the time that the reader looked away.

Embodiments of the present invention disclose a system and method for traversing through digital content in a manner not possible with paper-based content whereby a pageful of content is updated in partial sections so that certain parts can remain unchanged in order to maintain continuity while other parts are modified with new material in order to allow progress through the content. According to one embodiment, a touch gesture is received from a user on an electronic touchscreen device. A processing engine associated with the electronic device causes the electronic content to replace a portion of the screen with new content that is contiguous to the displayed content. For example, a tap of a finger on a touch screen display of the electronic device serves to replace substantially one half of the display with new content while the reader continues reading the existing content in the other half without having to lose any continuity in the reading of the content since the content being read has not been modified in any way. When the reader moves on to read the previously rendered new content, another tap of the finger on the touch screen display serves to replace the remainder of the display with newer content without any disruption to the progress of the reader. Accordingly, embodiments of the present allow a user to read content in a continuous and uninterrupted manner without scrolling or otherwise moving the content even as the content is being updated simultaneously.

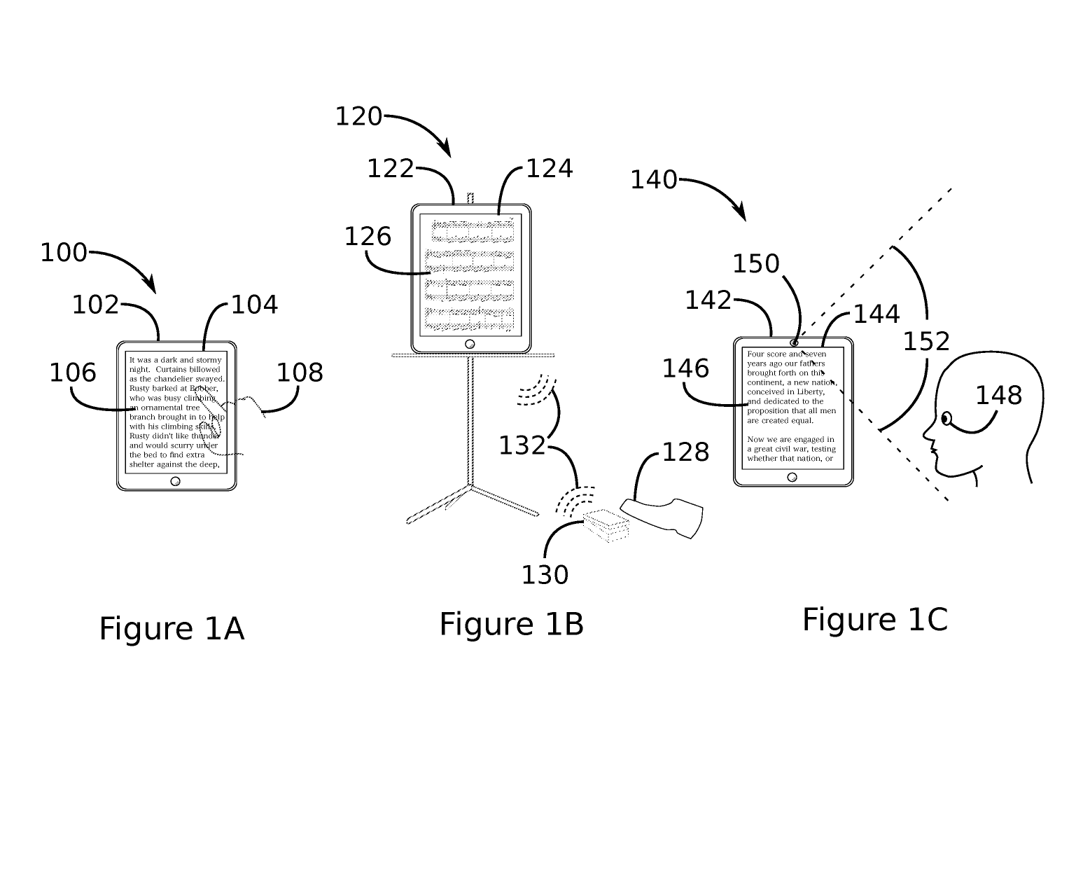

Referring now to FIG. 1A, an exemplary operating environment for an electronic tablet touchscreen computer device is illustrated in accordance with an embodiment of the present invention. As shown in FIG. 1A, an electronic tablet touchscreen device 100 includes a display enclosure 102 and a video display unit 104 configured to display digital content 106. Display unit 104 includes a touchscreen display configured to detect the presence and location of a user's hand 108, either through close proximity or actual contact between some part of the hand and the touchscreen. In this exemplary illustration, digital content 106 is of a textual nature—such as an article from a magazine or a page from a book—and the user uses a touch of a finger against the display in order to issue a request for an update to the displayed content so that reading may continue beyond the currently displayed content.

Referring now to FIG. 1B, an illustration of another environment for traversing through electronic content of an electronic device is provided. An electronic device 120 includes a display enclosure 122 and a display unit 124 configured to display digital content 126. In this embodiment, digital content 126 is of a musical score, the reading of which may be temporally sensitive since the playing of an instrument based upon the musical score is generally strictly governed by a rhythm and pace. The smooth progression in the playing of the instrument may suffer if a page turn interrupts the continuity of the reading of the score. In some embodiments, the trigger to update the content of a displayed page in order to make progress is accomplished not directly with device 120 but through a physically remote device. In this exemplary illustration, a user's foot 128 operates an electro-mechanical button fashioned in the form of a foot pedal 130. Foot pedal 130 is connected to electronic device 120 through a wireless data connection represented by signals 132.

Referring now to FIG. 1C, an illustration of yet another embodiment for traversing through electronic content of an electronic device is provided. An electronic device 140 includes a display enclosure 142 and a display unit 144 configured to display digital content 146. In this embodiment, digital content 146 is of a script where the user needs to speak in a smooth and continuous manner and so any disruption from page turns where the content is momentarily absent from view may present an undesirable effect. Here, the position of a user's eyes 148 are used to determine if a trigger for an update to the content can be assumed to have occurred. In this embodiment, a camera 150 is mounted close to display unit 144 and is able to accept a live video stream within a frame delimited by field of view lines 152 indicating the area within which the user looking at display unit 144 can be usefully captured by camera 150 so that the gaze of the user can be assessed to determine the portion of display 144 the user is currently reading.

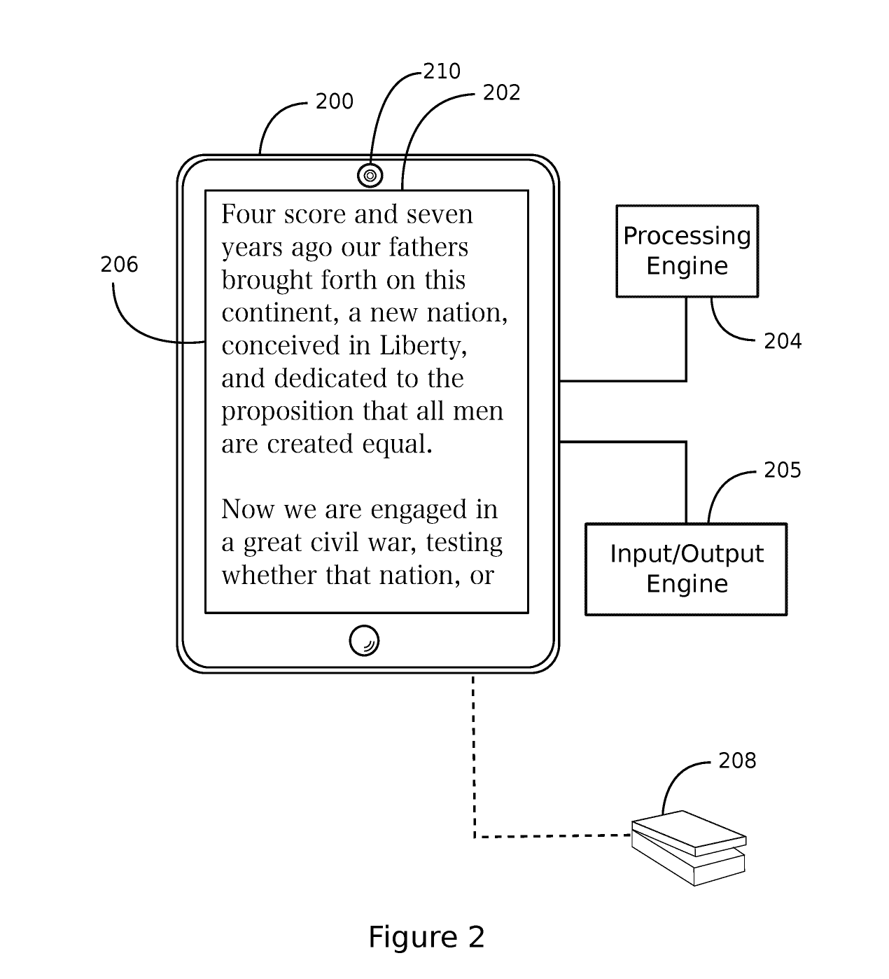

Referring now to a more detailed description of some of the embodiments, FIG. 2 provides an illustration of a typical tablet electronic computing device displaying electronic content in accordance with some embodiments of the present invention. Electronic device 200 includes a display unit 202 coupled to a processing engine 204. Processing engine 204, which executes and carries out instructions of a software application, is configured to accept input from a variety of sources through an input/output engine 205. Input/output engine 205 is capable of accepting input through a variety of hardware components. For example, in some embodiments, the input source is from a touch screen 206, touch screen 206 affixed over display unit 202 so that a user can seemingly interact with content rendered on display unit 202. Any interaction by a user touching touch screen 206 is accepted as an input event by input/output engine 205, which itself is comprised of a number of hardware and software components well known to those skilled in the arts. Touch screen 206 may comprise of a resistive touchscreen panel, a capacitive touchscreen panel, an infrared touchscreen panel, or the like. The touchscreen device may be configured to detect a user's physical touch or a hover event, in which an object such as a finger or stylus is not physically touching touch screen 206, but is in close proximity to touch screen 206. A touch is understood to mean one of any number of gestures interpreted to be a request for an update to the content, including but not limited to, a single touch, a swipe gesture, a touch with multiple fingers, or any of a number of other possibilities.

In some other embodiments, the input source is from an external device, shown here as an external pedal 208, connected to device 200 and processing engine 204 via wired or wireless connection through input/output engine 206. According to some embodiments of the present invention, traversing through pages of digital content is accomplished via a request signal sent from actuating a physical button communicating with the computing device through wired or wireless connections. Wired connections may include, but is not limited to, a Universal Serial Bus (USB) port. Wireless connections may include, but is not limited to, Bluetooth protocol or standard wife networks. The physical button is understood to be anything that may be equivalent to a physically actuated device that sends a signal to request an update to the content. For example, a physical slider or a light sensor, or any number of other hardware devices that is able to accept a change in state and relay it to device 200 would be suitable as an external input source.

In still other embodiments, the input source is from a camera 210 mounted close to display unit 202 so that a user looking at display unit 202 will be captured by camera 210, which can then send data to processing engine 204 for analysis of the user's visual focus. Various ways to analyze a user's face exist and algorithms for determining the target of a user's gaze through eye tracking exist and are well known to those skilled in the arts. It is understood that, in general, a camera operatively associated with device 200 does not necessarily need to be mounted to device 200 but can be operated remotely, through a wired or wireless connection. It is understood that the data captured by a camera acting as an input source may be based upon standard visual image components, such as red, blue, and green channels that may be combined to form images of a viewable video. It is also understood that the data captured by a camera acting as an input source may be based upon infrared data, depth data, or other environmental data that may be analyzed usefully so that user movement or gestures may be interpreted as a trigger requesting a partial page turning update.

The digital content being traversed through by a user in the present invention may be any type of medium that includes electronic content or text that exists in digital format or has been digitized in some way to present equivalent content on a digital device as would be found through its traditional delivery medium. The nature of the content in the present invention is generally of a form and structure that will cause it to occupy multiple display screens on a digital device in order to remain readable and the content itself may be of a textual or non-textual nature. This includes, but is not limited to, books, scripts, magazines articles, newspapers, musical scores, or virtually any other content, static or interactive, that requires a user to traverse through multiple pages within the content.

It is understood that the device in the illustrative example of FIG. 2 is offered without loss of generality and actual electronic devices may offer a more limited set of features. For example, a book reader may have a touch sensitive screen but no cameras or ability to receive input from external devices for actuating a page turn. Alternatively, a teleprompter may only have a camera but no capabilities for accepting input from a touch sensitive screen or external devices. While many commercially available devices currently on the market, such as the Apple iPad, provides numerous input possibilities within one device, the method and system of the present invention is not limited to devices that offer multiple input sources.

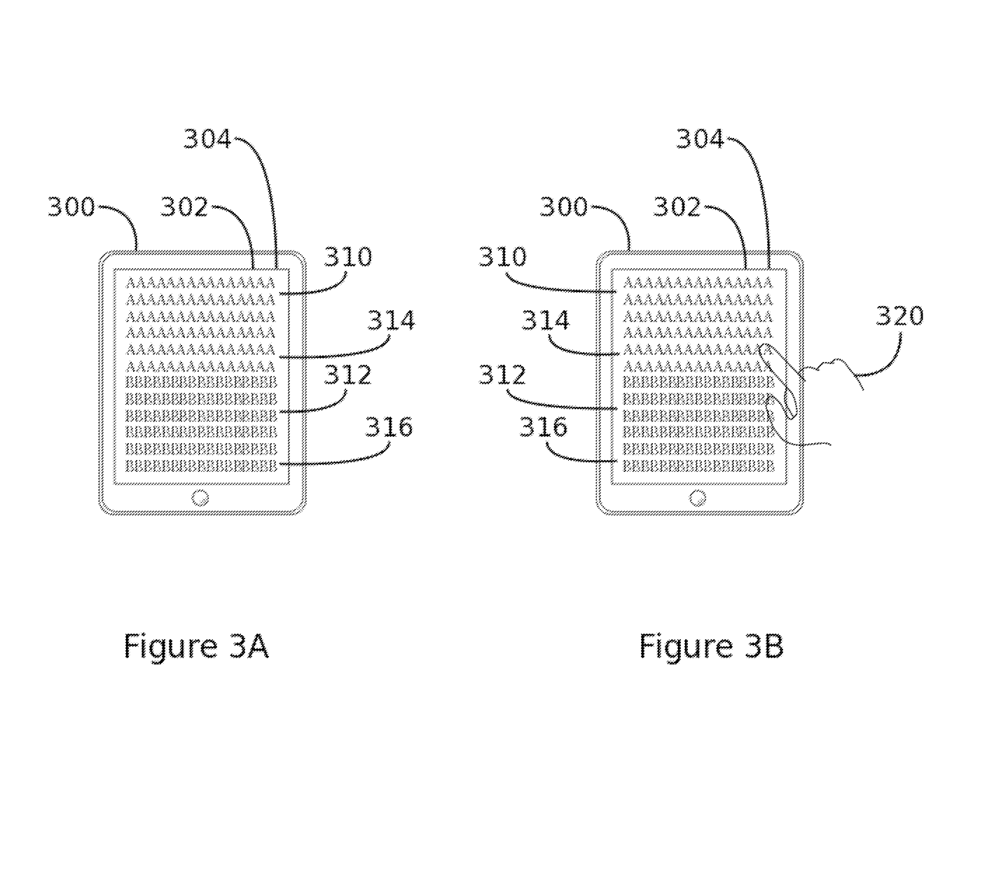

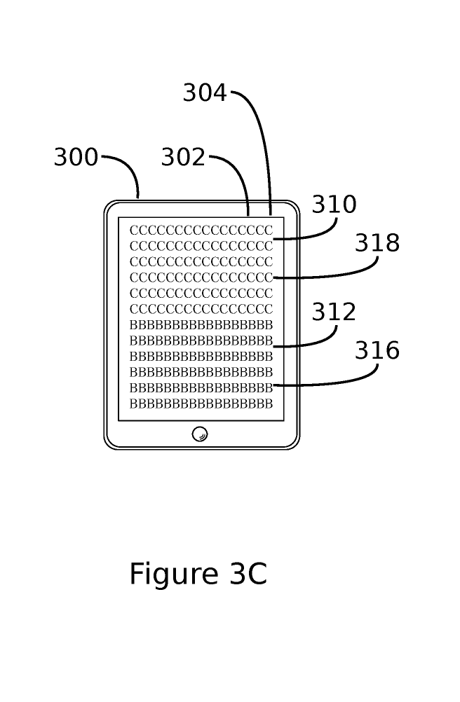

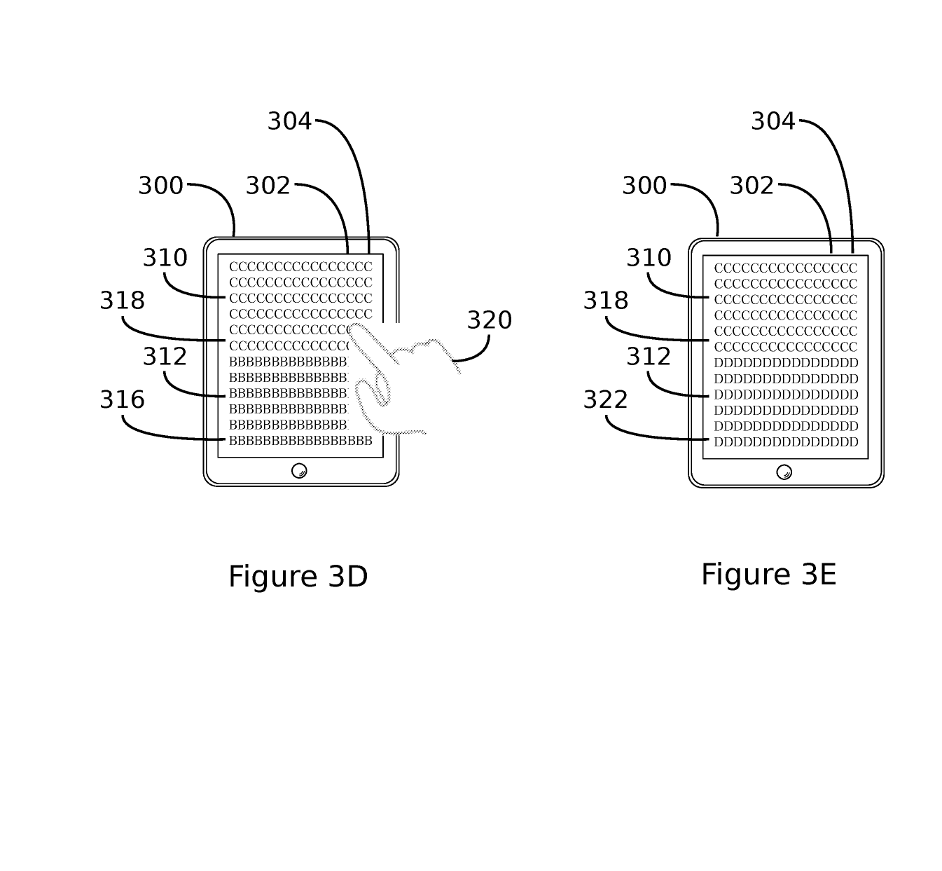

Referring now to FIGS. 3A through 3E, where like numerals identify corresponding parts throughout the views, a process flow is shown for traversing through digital content on an electronic device. In the illustrative example, the digital content being viewed and traversed has been simplified—for the sake of clarity and without loss of generality—and is represented as a series of repeating letters, each distinct set of repeated letters representing a distinct section of the content.

Referring now to FIG. 3A, in one embodiment of the present invention, computing device 300 has a display unit 302 and a touch sensitive input touchscreen 304 overlaid on display 302. Display unit 302 is divided into two sections, an upper portion 310 and a lower portion 312. For illustrative purposes, the text shown in FIG. 3A is divided into two section with distinctively different content so that upper portion 310 is rendered completely by the content of a first text section 314 comprising entirely of the character “A” repeated over several lines and lower portion 312 is rendered completely by the content of a second text section 316 comprising entirely of the character “B” repeated over several lines.

Referring now to FIG. 3B as well as FIGS. 3A and 3C, a user touches input screen 304 to issue a first update request action in order to traverse forward in the content. This results in a transition from the rendering of the text content from the configuration shown in FIG. 3A to the configuration shown in FIG. 3C. Specifically, after the user has touched touchscreen 304 of display 302 in the first update request action, the content of first text section 314 is replaced completely by a third text section 318, where third text section 318 is comprised of a set of characters “C” repeated over the same several lines and rendered over the entirety of upper portion 310. The update request action is typically composed of touchscreen 304 sensing a touch event by a finger or an equivalent surface that registers an electronic signal to touchscreen 304 and causing the computer processor to invoke existing computer code to create a programmatic response in reaction to the touch event, typically interpreted as an update request upon removal of hand 320 upon touchscreen 304. The content of lower portion 312 remains unchanged and retains the original content of second text section 316 comprising entirely of the character “B” repeated over several lines.

Referring now to FIG. 3D as well as FIG. 3E, the a user touches touchscreen 304 to issue a second update request action. The second update request causes the content of second text section 316 to be replaced completely by a fourth text section 322, comprised entirely of the characters “D” repeated over the same several lines and rendered over the entirety of lower portion 312. The content of upper portion 310 remains unchanged and retains the original content of third section 318 comprising entirely of the character “C” repeated over several lines.

In some embodiments, if the content has been exhausted, the remaining display area of an updated portion will be rendered in the background color or pattern so that content from the previous displayed text will no longer be visible. For example, if the content from the previous example terminated after the first line of the characters “C” then, after the first update request action is made, only one line of “C” characters will be rendered on display unit 302 but, rather than allow the subsequent lines of “A” characters to be visible, the remainder of upper portion 310 will be rendered with a background substantially similar to the background that is behind the line of “C” characters being displayed so that none of the content from the previous text section will be visible in the portion of the screen being updated.

Although embodiments of the present invention depict a finger as the touchscreen gesture, the invention is not limited to such an interface. For example, the touchscreen gesture may be a stylus or similar object used for touchscreen input and may not, in fact, involve physical contact as it may be sensed optically (e.g. hover event) as well as physically (e.g. on-screen touch). Furthermore, in alternative embodiments, instead of screen interaction, an external button, foot pedal, or some other triggering mechanism capable of sending a signal to the computing processor that an update request action has been requested by the user, can be equivalently used to fulfill the request task, as shown in FIGS. 1A and 1B. It is understood that an externally activated trigger can be generalized to cover a wide variety of input sources. The sensing, recognition, or detection of any sort of user movement or signal functionally can be programmed into computing device 300 to act as a trigger. For example, a hand waving gesture recognized by a motion sensor or depth sensor can serve as a trigger, as can an audio signal or in general any activity that can be mapped onto a sensing device that can, in turn, generate a trigger for a computing device to accept. Such input possibilities are well known to those skilled in the arts.

Furthermore, it is understood that, although the given embodiment uses text as the content, any form of content including text, images, musical notation, or other media that may be part of viewable digital content that extends over multiple screens would be handled in a similar manner as described in this illustrative example.

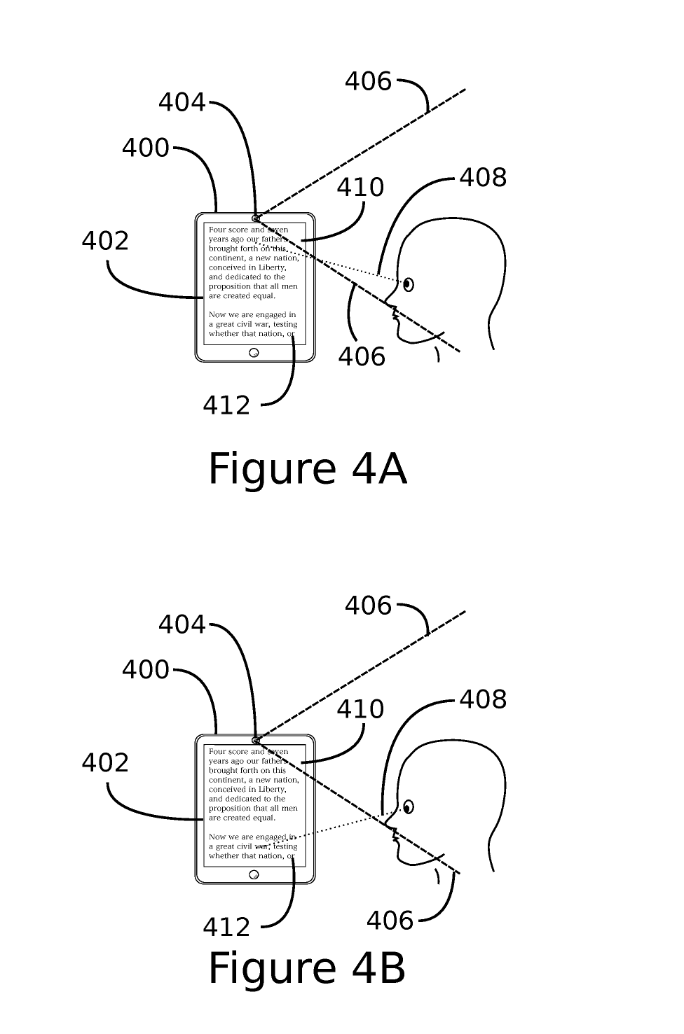

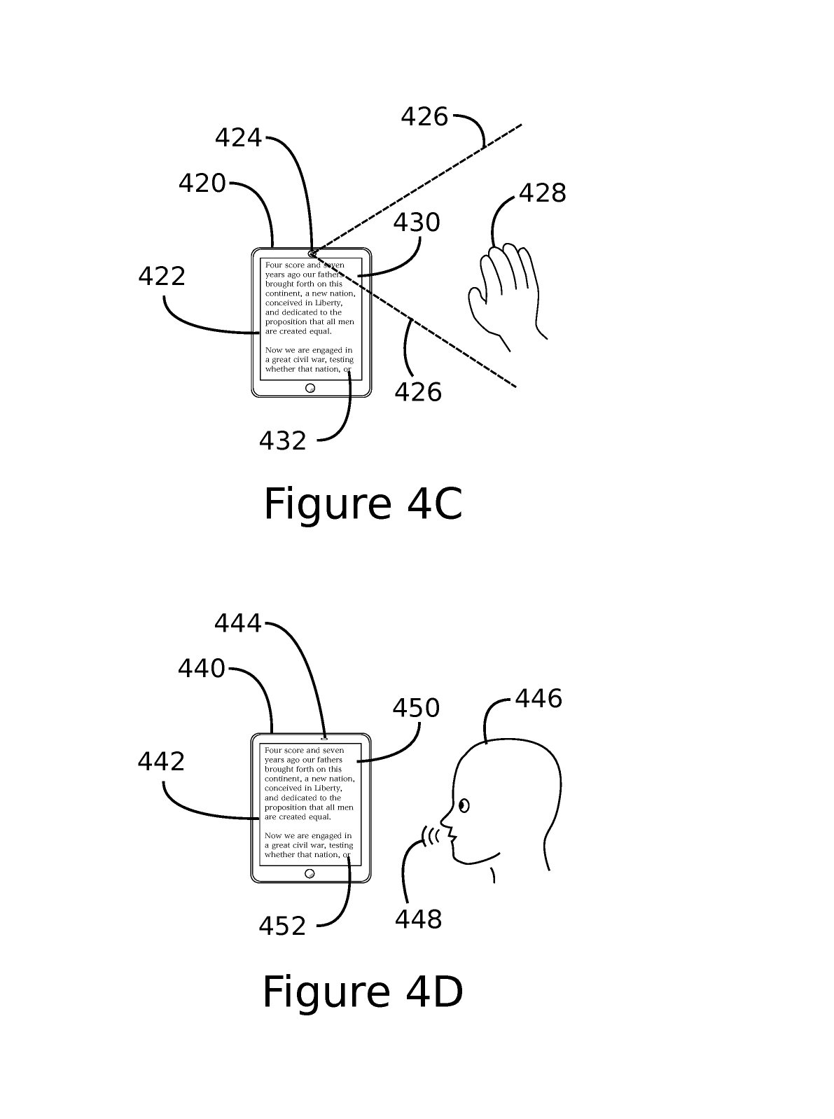

Referring now to FIG. 4A, one embodiment of the present invention employs a computing device 400 with a display unit 402 and integrated camera 404. Camera 404 is mounted directly above display unit 402 and is therefore positioned to capture the face of the user when the user is looking at display unit 402. Typical camera-enabled tablet based computing devices subtend an angle of approximately 65 degrees as indicated by delimiting boundaries 406. Such an angle would generally suffice to include the eyes of a user looking at the device. Camera 404 is capable of capturing video at a frame rate that would be acceptable as real-time at a resolution allowing an analysis of the facial features of the user. For example, most commercially available tablet computers offer front-facing cameras that can capture colored images with a resolution of 480 by 640 pixels at approximately 15 frames per second while allowing additional processes to execute in the background. In many devices currently available on the market, dedicated processors for camera and graphical operations are included so that the central processor is free to perform computational calculations without being hindered by video operations and so will retain computational efficiency. Frames of the captured video including the user's face are analyzed to determine the portion of the screen the user is looking at based upon the positions of the user's eyes and pupils as well as the user's head position and angle. Techniques for deducing the user gaze exist in many forms including geometrically based pose derivation, machine learning image categorization, and other heuristics well known to those skilled in the arts.

Referring still to FIG. 4A, the target of a user's gaze 408 can be deduced from the video images captured by camera 404 and, if it is determined that the target of the user's gaze has been generally confined to upper portion 410 of display unit 402 for at least some minimal amount of time, such as 75% of total gaze time, and that there was either no previous page update request made or that the previous page update request was made for upper portion 410 rather than for lower portion 412, then the content rendered within lower portion 412 is updated with content contiguous and continuing from the content rendered in upper portion 410.

Referring now to FIG. 4B, if the target of the user's gaze 408 is determined to have been generally confined to lower portion 412 of display unit 402 for at least some minimal amount of time, such as 75% of total gaze time, and that the previous page update request made was for lower portion 412 rather than upper portion 410, then the content rendered within upper portion 410 is updated with content contiguous and continuing from the content rendered in lower portion 412.

In some embodiments, certain movement patterns of the user's eyes are considered optimal times for traversing through the digital content. For example, a gaze concentrating on substantially upper portion 410 with minimal deviation may be deduced as a user reading the content of upper portion 410 making it ideal to update of lower portion 412 since the user is not focused on lower portion 412. Conversely, a gaze concentrating on substantially lower portion 412 with minimal deviation may be deduced as a user reading the content of lower portion 412 making it ideal to update of upper portion 410 since the user is not focused on upper portion 410. Minimal deviation may be defined as perceived movement of the user's eyes within a portion of the screen to stay substantially within that portion of the screen rather than, say, darting around the screen, which may be a sign that the user is not carefully reading the content but searching and scanning for particular features, in which case, in certain embodiments, a visual cue can be given to the user that no update page request can be deduced by the user's eye movement.

Referring now to FIG. 4C, another embodiment of the present invention employs a computing device 420 with a display unit 422 and integrated camera 424. Typical camera-enabled tablet based computing devices subtend an angle of approximately 65 degrees as indicated by delimiting boundaries 426. Display unit 422 contains content in an upper portion 430 and a lower portion 432. Integrated camera is able to recognize a gesture by a hand 428 moving in a particular manner, the particular manner can be a sweeping motion from right to left, a quick flick upwards, a closed first opening into an open palm, or any one of a number of movements, the recognition algorithm for which is well known to those skilled in the art. When such a gesture is recognized, a partial update is executed in display unit 422 so that content contiguous and subsequent to the displayed content is first displayed in upper portion 430 and, with every subsequent recognized gesture, consecutively contiguous content is alternately displayed in lower portion 432 and upper portion 430.

Referring now to FIG. 4D, yet another embodiment of the present invention employs a computing device 440 with a display unit 442 and integrated microphone 444. Display unit 442 contains content in an upper portion 450 and a lower portion 532. Integrated microphone 444 is able to recognize a particular audio cue such as a short phrase like “Next page”, a whistle, a click of the tongue, an artificial noise made by a physical object, or any sound that can be distinctively recognized by sound recognition system, the technology for which is well known to those skilled in the art. When an audio cue is recognized, a partial update is executed in display unit 442 so that content contiguous and subsequent to the displayed content is first displayed in upper portion 450 and, with every subsequent recognized gesture, consecutively contiguous content is alternately displayed in lower portion 452 and upper portion 450.

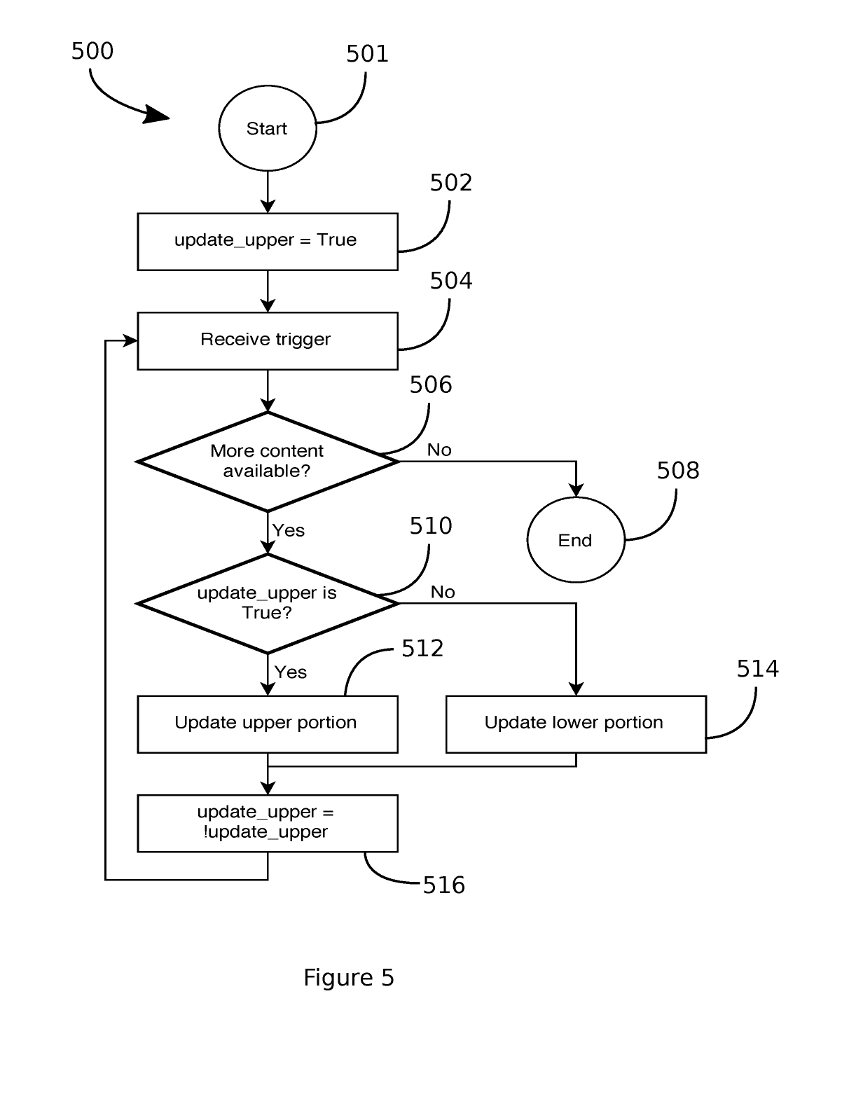

FIG. 5 illustrates the processing steps for traversing through electronic content of an electronic device according to an embodiment of the present invention. In step 502, a boolean variable update_upper is set to True. In step 504, a user trigger action is received through some input source. The user trigger action here can refer to an active actuation of a physical pedal by the user, a tap on a touch screen by the user, or any number of other user initiated action. The user trigger here can also refer to passive recognition of a user state, such as the target of a user gaze as analyzed through images captured by a camera. Typically, in such a step, the computing system considers the process awaiting user input to be in a sleep state so that the execution of the instruction is effectively suspended until such time that a user trigger action is received. Once a trigger action is received, a step 506 checks to see if more content is available for display. If no more content is available, the process branches to step 508 where execution ends or is otherwise diverted to some routine, such as one that offers some message to the user indicating that the end of the content has been reached, or one that presents users with options to return to another part of the content, or any of a number of other user experience possibilities well known to those skilled in the arts.

If the check at step 506 indicates that more content is available, execution then proceeds to a step 510 where a check is made for the state of the variable update_upper and, if it is set to True, execution branches to step 512 where the upper portion of the display is updated with content that immediately follows the content displayed on the lower portion of the display. If update_upper is set to False, then execution breaches to step 514 where the lower portion of the display is updated with content that immediately follows the content displayed on the upper portion of the display. Once the display has been rendered with the new content in whichever portion was updated, the variable update_upper is toggled at step 516 so that a True state becomes False and a False state becomes True. In this way, in the next iteration, the portion that was not updated in the current iteration will be the portion to be updated. Execution then returns to step 504 where the process awaits the next user trigger in order to begin the next iteration of updating the display in order to progress further in the content.

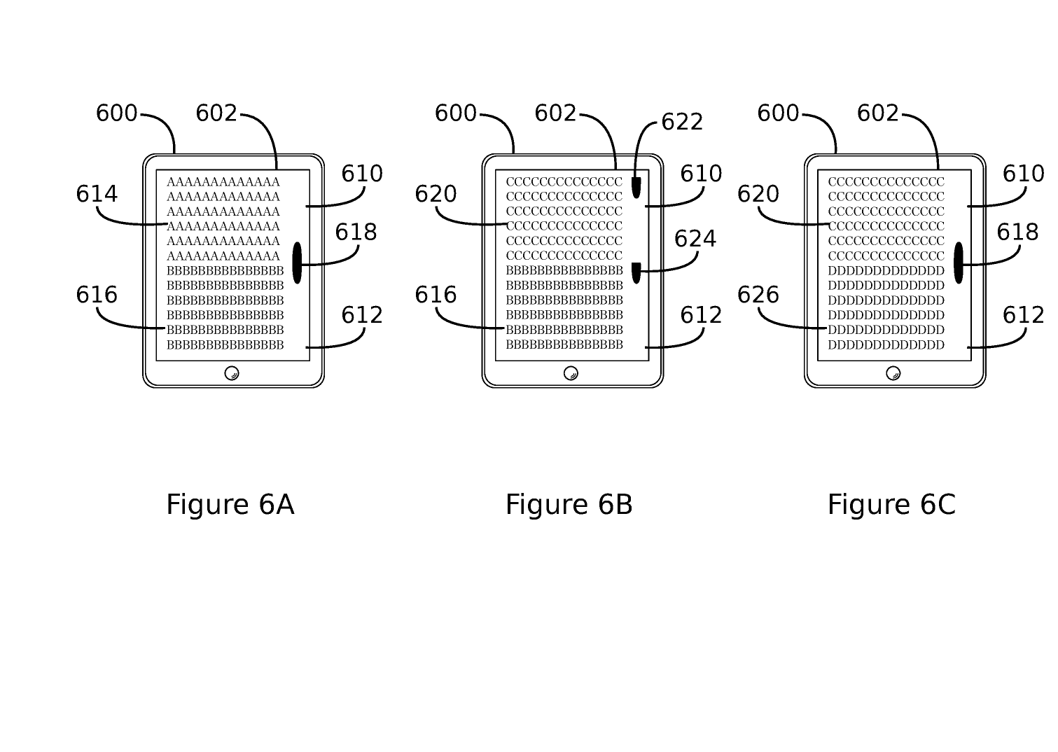

In some embodiments, a visual cue is provided to indicate if the two portions of the displayed content are contiguous. Referring now to FIG. 6A, some embodiments provide visual cues to indicate if the portions of the displayed content are contiguous. A device 600 includes a display unit 602, display unit 602 being divided into an upper portion 610 and a lower portion 612 where upper portion holds upper content 614 and lower portion 612 holds lower content 616. In this illustrative example, lower content 616 follows directly from upper content 614 in a continuous and contiguous manner. A visual cue in the form of a full oval 618 is rendered to indicate that the displayed content is in one contiguous piece.

Referring now to FIG. 6B as well as 6A, after a user has requested an update to the displayed content, upper portion 610 is updated with new upper content 620 replacing upper content 614, new upper content 620 being content that continuously and contiguously follow lower content 616. Visual cue 618 is now replaced with two half ovals: an upper half oval 622 and a lower half oval 624. Upper half oval 622 and lower half oval 624 are positioned separately so as to be disconnected and, in the illustrative example, placed at a separation of approximately half the height of the display area of display unit 602. In this way, it is easily discerned that upper portion 610 and lower portion 612 do not hold contiguous content.

Referring now to FIG. 6C as well as FIGS. 6B and 6A, after the user has requested a second update to the display content, lower portion 612 is updated with new lower content 626 replacing lower content 616, new lower content 626 being content that continuously and contiguously follow new upper content 620. With the content rendered on display unit 602 contiguous within the displayed area, upper half oval 622 and lower half oval 624 are removed and replaced with full oval 618 indicating that the displayed content is in one contiguous piece. It is understood that the visual cue, represented in this illustrative example as an oval and oval halves, can assume any number of shapes, sizes or visual representations. For example, small arrows in the margin may be used instead of the full oval and half ovals. Alternatively, the background color or pattern in the portions may be changed to indicate continuity or discontinuity so that continuous content would share the same background color and/or pattern and discontinuous content would have different background colors and/or patterns. Also, the visual cues do not need to be static but could be animated and transient. For example, upon changing to content that creates a discontinuity, the updated portion can initially assume a relatively dim color which brightens over time until it matches the brightness level of the unchanged portion. The animated visual cue provides an indication of changed content without relying on screen real estate to maintain a static visual cue. The rate of animation may be calibrated to be fast enough so as to make the content available quickly but slow enough so as not to create a disruptive distraction. Other forms of cues—visual, audio or otherwise—may be provided to indicate changed content and are well known to those skilled in the arts.

Embodiments of the present invention enable a user of an electronic device to traverse through electronic content in a piecewise manner. In one embodiment, a user trigger is actuated via a touch screen interface where a touch by a user upon a touch sensitive screen sends a request to partially update a page. In another embodiment, an external physical button is used to trigger a partial page update. In yet another embodiment, a camera is used to recognize a user's gaze and the amount of time a user is gazing at one portion of a screen is used to update the other portion of the screen if the other portion of the screen was not the portion just previously updated.

Many advantages are afforded by providing a user with a way to partially update content on a display of an electronic device. The partial update of a display by portion allows for a transition that is continuous and without any lapse in content display or movement of content that may require substantial user attention. In one embodiment, a touch by a user upon a touch sensitive screen updates content of displayed content in a piecewise manner so that current content remains unchanged for the user to continue reading while content in another portion of the screen is updated so the user can focus on that content without any disruption in the display when the focus is changed. Furthermore, the partial page update in the embodiments of the present invention has a relatively simple and quick configuration process, and therefore can be easily adopted into current electronic devices. Accordingly, embodiments of the present invention provide an efficient and logical page updating method that can be immediately employed in today's marketplace in order to help users navigate electronic content in a smooth and easy manner that may be particularly useful in performances that require musical scores, speeches that require teleprompters and other situations where continuous transitions between pages are desired.

Furthermore, while the invention has been described with respect to exemplary embodiments, one skilled in the art will recognize that numerous modifications are possible. For example, although exemplary embodiments depict an electronic reading device as the electronic touchscreen device, the invention is not limited thereto. For example, the electronic touchscreen device may be a netbook, a tablet personal computer, a cell phone, a projective screen system with a gesture recognizer to capture user interaction with the screen, or any other electronic device configured to receive gestures as interaction with the system and display electronic content associated with electronic media. As another example, while the embodiments presented here depict content shown as single page entities covering substantially the entire display area, embodiments that have content rendered over multiple pages on one display can be served by the mechanisms disclosed in this invention. Thus, although the invention has been described with respect to exemplary embodiments, it will be appreciated that the invention is intended to cover all modifications and equivalents within the scope of the following claims.

What is claimed is:

1. A method for advancing from a rendered section of electronic content on an electronic device having a display and a processing engine, to rendering a subsequent section of said electronic content, said subsequent section of said electronic content continuously subsequent to said rendered section of said electronic content, said method comprising:
receiving a first trigger event;
causing, via said processing engine, a first portion of said displayed section of said electronic content to be replaced by a first portion of said subsequent section of said electronic content;
receiving a second trigger event;
causing, via said processing engine, a second portion of said displayed section of said electronic content to be replaced by a second portion of said subsequent section of said electronic content.

2. The method of claim 1, wherein said display includes a touchscreen surface and said first trigger event and said second trigger event are received via one or more touch gestures from a user.

3. The method of claim 1, wherein said first trigger event is received via an actuation of a physical button and said second trigger event is received via an actuation of said physical button or of a different physical button.

4. The method of claim 1, wherein said electronic device is operatively associated with a camera utilizing said camera's image data to track a user's eyes generating said first trigger event from a recognition of said user's eyes gazing at a bottom area of said display for a minimal amount of time and generating said second trigger event from a recognition of said user's eyes gazing at a top area of said display for another minimal amount of time.

5. The method of claim 1, wherein said electronic device is operatively associated with a motion sensor, said motion sensor generating said first trigger event and said second trigger event based upon some recognized movement or movements by a user.

6. The method of claim 1, wherein said electronic device is operatively associated with a microphone, said microphone generating said first trigger event and said second trigger event based upon some recognized audio signal.

7. The method of claim 1, further including a visual cue rendered upon said display indicating the state of continuity between content displayed on said first portion and content displayed on said second portion.

8. The method of claim 1, further including an animated visual cue rendered upon said display when content is replaced in said upper portion or said lower portion of said displayed section of said electronic content.

9. A system for traversing through electronic content, said system comprising:
a processing engine;
a display, said display including a first portion and a second portion;
a rendering means, said rendering means capable of rendering a section from said electronic content on said first portion of said display and separately rendering another section from said electronic content on said second portion of said display;
a trigger means, said trigger means accepting a plurality of first trigger events and a plurality of second trigger events, each first trigger event from said plurality of first trigger event resulting in said first portion of said display to be updated with a rendering of a new section from said electronic content, said new section from said electronic content contiguously following said another section from said electronic content, and each second trigger event from said plurality of second trigger events resulting in said second portion of said display to be updated with a rendering of a new another section from said electronic content, said new another section from said electronic content contiguously following said new section from said electronic content.

10. The system of claim 9, wherein said display includes a touchscreen surface and said trigger means receives said upper trigger events and said lower trigger events via one or more touch gestures from a user.

11. The system of claim 9, wherein said upper trigger events are received via an actuation of a physical button and said lower trigger events are received via an actuation of said physical button or of a different physical button.

12. The system of claim 9, wherein said system is operatively associated with a camera utilizing said camera's image data to track a user's eyes generating said upper trigger events from a recognition of said user's eyes gazing at a bottom area of said display for a minimal amount of time and generating said lower trigger events from a recognition of said user's eyes gazing at a top area of said display for another minimal amount of time.

13. The system of claim 9, wherein said system is operatively associated with a motion sensor, said motion sensor generating said upper trigger events and said lower trigger events based upon some recognized movement or movements by a user.

14. The system of claim 9, wherein said system is operatively associated with a microphone, said microphone generating said upper trigger events and said lower trigger events based upon some recognized audio signal.

15. The system of claim 9, further including a visual cue rendered upon said display indicating the state of continuity between content displayed on said upper portion and content displayed on said lower portion.

16. The system of claim 9, further including an animated visual cue rendered upon said display when content is replaced in said upper portion or said lower portion of said displayed section of said electronic content.
